(19) United States
(12) Patent Application Publication
(10) Pub. No.: US 2004/0267560 A1
(43) Pub. Date: Dec. 30, 2004

(54) Method of home inspection business including indoor air quality assessment

(76) Inventor: Craig Hostland, Kelowna (CA)

Correspondence Address: ANTONY C. EDWARDS, SUITE 800 - 1708 DOLPHIN AVENUE, KELOWNA, BC, V1Y 9S4, CA

(21) Appl. No.: 10/813,016

(22) Filed: Mar. 31, 2004

Related U.S. Application Data
(60) Provisional application No. 60/483,176, filed on Jun. 30, 2003.

(51) Int. Cl. G06F 17/60

(52) U.S. Cl. 705/1

(57) ABSTRACT

A method of conducting a home inspection business may be characterized as including the steps of offering to a customer a first inspection service limited to visual inspection of tangible attributes of a building; offering to the same customer a second inspection service including at least visual inspection for physical sources of non-tangible air-borne contaminants and toxins in the building; providing the first inspection service; and, providing the second inspection service contemporaneously in the building with the first inspection service at a cost effective price value that otherwise would be beyond the means of an average purchaser.

### CROSS REFERENCE TO RELATED APPLICATION

This application claims priority from U.S. Provisional Patent Application No. 60/483,176 filed Jun. 30, 2003 entitled Method of Home Inspection Including Indoor Air Quality Assessment.

### FIELD OF THE INVENTION

This invention relates to the field of improved home inspections and in particular to a home inspection reporting and delivery system which includes an assessment of the home's health based on an indoor air quality assessment, and a business model and method of providing a system including same.

### BACKGROUND OF THE INVENTION

It is known in the prior art that a prospective purchaser of a residential home will often have a pre-purchase home inspection undertaken by a third party professional service provider to assess the structural aspects of the home prospectively being purchased. Over the past decade many home inspection service providers have come to the market to offer their services to prospective home owners. For example, the “Pillar to Post”™ home inspection service providers advertise that they report on as many as 1600 interior and exterior items in a three hour deficiency survey. The survey relates to the house per se, and does not relate to indoor air quality (herein also referred to as “IAQ”) issues which might affect the health of the living environment in which the prospective home owners will eventually live. What follows is a description compiled from a contract for a home inspection service of which applicant is aware:

The inspection includes the visual examination of the home's exterior including roof and chimney, structure, electrical, heating and cooling systems, insulation, plumbing, and interior including floors, walls, ceiling and windows; it is a reasonable effort to disclose the condition of the house based on a visual inspection, Additionally, inspector will functionally operate major built-in appliances. Conditions beyond the scope of the inspection will not be identified. No engineering services are offered.

This Inspection Report is based on the condition of the property existing and apparent as of the time and date of the inspection. Not all conditions may be apparent on the inspection date due to weather conditions, inoperable systems, inaccessibility of areas of the property, etc. Without dismantling the house or its systems, there are limitations to the inspection. Throughout any inspection, inferences are drawn which cannot be confirmed by direct observation. Clues and symptoms often do not reveal the extent or severity of problems. Therefore, the inspection and subsequent Inspection Report may help reduce the risk of purchasing the property; however, an inspection does not eliminate such risk nor does the inspector assume such risk. While some of the less important deficiencies are addressed, an all inclusive list of minor building flaws is not provided. Inspector is not responsible nor liable for the non-discovery of any patent or latent defects in material, workmanship, or other conditions of the property, or any other problems which may occur or may become evident after the inspection time and date.

Inspector will not conduct geological tests; will not inspect inaccessible or concealed areas of the property; will not enter dangerous areas of the property; will not inspect for environmental concerns such as hazardous substances or gasses, including but not limited to, radon gas, asbestos, formaldehyde; or for fungus.

Consequently, conventional home inspections would not, for example, conventionally both report on home deficiencies and report on the presence of mould or fungus for example, and make an assessment of the impact on the indoor air quality, amongst many other air quality factors such as set out below. In applicant's view the consuming public when ordering a home inspection, and the home inspection service providers, will focus on visual inspection of tangible deficiencies of the building attributes per se and the functioning of its major appliances and equipment, and it would not be obvious given the state of the prior art that such consumers and service providers would turn their minds to the intangible or significantly less tangible air quality issues including visually inspecting for physical sources of non-tangible air-borne contaminants or toxins in the building which could nonetheless detrimentally affect the consumer's enjoyment and use of the building.

The need for an indoor air quality assessment is premised on the assumption that often the quality of air indoors is worse than the quality of air outdoors. Sick Building Syndrome (SBS) is a term used to describe situations where the occupants experience acute health and comfort effects that appear to be linked to the time spent in the building, but no specific illness or cause can be readily identified. A 1984 World Health Organization Committee report suggested that up to 30% of new and remodeled buildings worldwide may be the subject of excessive complaints related to IAQ. Cited causes, or contributing factors, of SBS include inadequate ventilation, chemical contaminants from indoor and outdoor sources, as well as biological contaminants.

There are a number of health signs and symptoms and related issues associated with SBS and IAQ. Some may mimic common cold & flu symptoms making recognition difficult. They include: rhinitis, nasal congestion, epostaxis, pharyngitis, cough, wheezing, worsening asthma, lung disease, dyspnea, conjuctival irritation, headaches or dizziness, lethargy, fatigue, malaise, nausea, vomiting, anorexia, cognitive impairment, personality change, rashes, fever, chills, tachycardia, retinal hemorrhage, myalgia, and hearing loss.

Contaminants and their sources may, non-exhaustively, be categorized as either being biological pollutants or chemical contaminants (although pollutant and contaminant are used interchangeably herein) as follows:

Biological Pollutants:

1. Mould/mildew/fungus—85% of all homes have mould and 10% to 35% have serious mould contamination. Prolonged exposure can cause the development of an allergy. Sources may include dead plant material, animals, humans, soil, air, dung, and, food.

2. Dust Mites—dust mites live in mattresses, pillows, carpets, fabric-covered furniture, bed covers, clothes, and, stuffed toys.

3. Pests—droppings or body parts of pests such as cockroaches or rodents can be asthma triggers.

4. Pollen—pollen is a fine, powder-like material consisting of pollen grains that is produced by the anthers of seed plants. Pollen aggravates existing allergies.

5. Animals—animals leave traces of dander, minute scales from hair, feathers, skin flakes, urine and saliva, all of which may aggravate an existing allergy.

6. Infectious agents such as bacteria or viruses may live temporarily in conditions ordinarily found from time-to-time in a house, for example in warm, moist environments.

Chemical Contaminants:

1. Carbon Monoxide (CO)—co may be found wherever fossil fuels are burnt such as chimneys and furnaces, back-rafting from furnaces, gas water heaters, wood stoves and fireplaces, gas stoves, automobile exhaust from attached garages, environmental tobacco smoke.

2. Carbon Dioxide (CO2)—In occupied areas, the concentration of carbon dioxide (CO2), a product of human respiration, is used as an indicator of inadequate ventilation. If levels are high, constant irritability and complaints from building occupants is expected.

3. Nitrogen Dioxide (NO2)—kerosene heaters, unvented gas stoves & heaters, combustion sources, environmental tobacco smoke.

4. Sulphur Dioxide (SO2)—combustion sources (such as coal, petroleum, kerosene, propane and oil).

5. Formaldehyde (HCHO)—pressed wood products (hardwood paneling, particle board, fibreboard) and furniture made with these pressed wood products, Urea Formaldehyde Foam Insulation (UFFI), combustion sources, environmental tobacco smoke, durable press drapes, other textiles, coated paper products, cosmetics, and glues.

6. Radon (Rn)—Sources include the earth and rock beneath a building, well water, building materials. Symptoms are not readily apparent with short-term exposure.

7. Volatile Organic Compounds (VOC's)—includes paints, paint strippers, other solvents, wood preservatives, aerosol sprays, cleaners, disinfectants, moth repellents, air fresheners, stored fuels, automotive products, hobby supplies, dry-cleaned clothes.

8. Pesticides—insecticides, termiticides, disinfectants, lawn and garden products

### SUMMARY OF THE INVENTION

Consequently, it is an object of the present invention to provide an improved home inspection method and a business model or system for the sale of the method, for the cost effective marketing and conducting of an indoor air quality investigation and assessment as an adjunct synergistic part of a home inspection service.

In one aspect of the present invention, the cost effective sale opportunity for the up-selling of an IAQ assessment presents itself to a prospective home owner, or is presented in some fashion to the prospective home owner so that the prospective home owner thinks about air quality issues as they relate to a specific home, before a conventional home inspection is completed, so that an air quality assessment may be undertaken at the time of the conventional home inspection. There is a latent demand for IAQ assessments of indoor environs by conscientious people and by those who are sensitive to their environment by to whom price point is a significant limiting factor. An IAQ assessment at the time of a home inspection provides a cost effective solution. For example, if a conventional pre-purchase home inspection is slated for a particular prospective home owner, then prior to home inspection commencing the prospective home owner may be contacted in an initial educational contact in order to establish the basis for, and then to close, the up-sale of the additional service. Otherwise, for example when the home inspector is on site, the home inspector may either follow up with the initial educational contact which earlier laid the basis with the prospective home owner, or initiate education of the prospective home owner on-site, as to the advantages of cost effectively combining the air quality assessment with the conventional home inspection at the same time as the conventional home inspection.

The educational contact, in which the prospective home owners are educated as to the issues relating to, and benefits of, indoor air quality assessments, may be concurrently undertaken by way of advertising, whether it be in printed publications, or by way of audio visual media including television, or in other visual media, or in a combination of these. The purpose of such education is to establish that a need exists for the service, the benefits of the service, and the potential risks including health hazards which exist from ignoring the service. Such education creates an impetus and momentum in the marketplace which will grow the demand for air quality assessments to such a point that it becomes the accepted norm or standard, that, firstly, a home inspection should be undertaken every time a home purchase is contemplated and, secondly, that the home inspection should automatically include in combination all aspects of indoor air quality assessment as for example taught herein. A service provider then attending on-site to provide a home assessment which included an indoor air quality assessment would have an opportunity for a further up-sale to the prospective home owner, for example the additional service of testing to determine toxicity or pathogenic elements and a remediation process to correct problem. The up-sale may also include, either from the inspection service provider where the regulatory scheme allows, or third party providers in return for a fee, associated hardware and maintenance or service agreements, all of which flow from the integration of the sale of indoor air quality assessments with the marketing and provision of conventional home inspection services.

In summary, the present invention is in one aspect characterized as a method of doing business by a home inspection service provider, the method including the steps of:

a) identifying a customer who has already committed to paying for a home inspection by the service provider, which home inspection is limited to a visual inspection of a building of interest to the customer as to determine the physical condition of the building and functioning of its associated major appliances and equipment;

b) continuing contact with the customer to provide an expanded sales-point time frame for educating the customer in respect of available indoor air quality inspection and assessment services and benefits thereof provided by the service provider and the risks attendant in ignoring indoor air quality;

c) educating the customer in the expanded sales-point time frame in respect of available indoor air quality inspection and assessment services and benefits thereof provided by the service provider, the risks attendant in ignoring indoor air quality, and the cost-effectiveness of having a home inspection and indoor air quality inspection and assessment done contemporaneously;

d) providing the customer with the choice of having an indoor air quality inspection and assessment conducted by the service provider contemporaneously with the home inspection of the building of interest;

e) recording the customer's preference; and,

f) performing the home inspection and, if in accordance with the customer's preference, also performing, contemporaneously with the home inspection, an indoor air quality inspection and assessment of the building of interest,

all within a cost effective thorough system that otherwise would cost customer significantly more for a home inspection and an IAQ assessment where each is done separately, that is for those consumer's where cost is a barrier.

Consequently, what is provided is a much needed service in a price range that will not be a barrier. In one embodiment, these steps may be consecutive. It may be the case where the step of continuing contact with the customer is initiated prior to the conducting of the home inspection. It may also be the case where the step of continuing contact with the customer is conducted contemporaneously with the conducting of the home inspection.

The method of conducting a home inspection business according to the present invention may also be characterized as including the steps of:

a) offering to a customer a first inspection service limited to visual inspection of tangible attributes of a building;

b) offering to the same customer a second inspection service including at least visual inspection for physical sources of non-tangible air-borne contaminants including toxins in the building;

c) providing the first inspection service; and,

d) providing the second inspection service contemporaneously in the building with the first inspection service.

The home inspection may be characterized as the first inspection service and the indoor air quality inspection and assessment may be characterized as the second inspection service. The second inspection service may include steps chosen from the group of steps comprising:

a) inspecting landscaping/drainage for possible conditions which may cause infestation problems,

b) inspecting for exterior wall penetrations/damage so as to identify causes of past/present water intrusion,

c) testing to detect high moisture levels behind finished walls,

d) checking venting of furnace and hot water tank for indications of flue gas backflow into the house which may indicate an air imbalance in the home,

e) reviewing on-site storage for hazardous products, including chemicals, phenols, asbestos and combustibles,

f) checking for odour to identify organics, phenols, mould/mildew,

g) checking of windows, basement and attic for mould/mildew including for fungus or other growths, and sampling materials for testing,

h) checking for excess moisture including window condensation, faulty toilet seals, high moisture levels behind tub surrounds,

i) checking carbon monoxide level,

j) inspecting for asbestos.

The first inspection service may include steps chosen from the group of steps comprising:

a) determining building type,

b) determining site condition,

c) determining weather conditions at time of conducting inspection,

d) determining site development,

e) inspecting the exterior of the building,

f) inspecting the roof of the building,

g) inspecting any attic of the building,

h) inspecting any garage of the building,

i) inspecting any mechanical equipment of the building,

j) inspecting any interior development of the building.

The first and second inspection services may be conducted simultaneously and:

a) the step of inspecting the roof of the building may include inspecting for active leaks, water staining or biological growth,

b) the step of inspecting any garage of the building may include:

(i) inspecting for odours and for causes of odours including organic or chemical causes and for visible rot or decay,

(ii) inspecting for storage of gasoline, paints, garbage or organics,

c) the step of inspecting any mechanical equipment of the building may include inspecting any humidifier for biological build-up, a lack of ventilation causing moisture leading to mould,

d) the step of inspecting any interior development may include:

(i) inspecting for the presence of cleaning products including of a perfumed (trigger) or hazardous type,

(ii) inspecting for active water leaks, stains or biological build-up, and potential for hidden moulds,

(iii) inspecting windows for water damage or biological build-up (indicating environment for mould growth).

Again, these steps may be consecutive. A health questionnaire of both vendor and purchaser may help to illicit or draw-out a relationship between the home-owners or tenants health and home indoor air quality. The questionnaire increases awareness, allows client to address further with the client's doctor and is provided as a part of an economical service not otherwise available to the client.

Another advantage of the method of the present invention is that the IAQ add-on offer or up-sale from a home inspection is a marketing tool to create awareness of the inspector's ability to assess IAQ/mould issues which enhances his ability, through word of mouth to secure more work—an economical marketing tool to expand the business opportunity.

### DETAILED DESCRIPTION OF EMBODIMENTS OF THE INVENTION

The indoor air quality assessment which will generate revenue from the add-on or up-sale opportunity provided by conventional home inspection services, will focus on for example, without intending to be limiting, the environmental contamination resulting from poor ventilation, building envelope failure, moisture intrusion and/or high moisture content resulting in mould growth, and improper storage/presence of hazardous materials. The potential air quality factors that would be considered are also listed below in the accompanying indoor air quality (IAQ) marketing script contained in Table 1. Further, more of the specific air quality factors to be assessed are set out in the IAQ inspection checklist which is the subject of Table 2 below. It is intended that an inspector providing an IAQ assessment would, at a minimum, observe visible surfaces within a building for sources of air-borne toxins and fungal growth, observe improper storage/presence of hazardous materials, observe inadequate ventilation and/or combustion of appliances.

The IAQ script of Table 1 would be used, as described above, in taking advantage of an already booked conventional home inspection, that is, one that has yet to happen but which is going to be done by the service provider. A contact may be made subsequent to the booking but prior to the date of the on-site inspection as part of an economical marketing strategy that allows for low overhead and therefore reduced fees necessary to cover costs. A representative of the home inspection service provider contacts the prospective home owner and follows the methodology of the script so as to present to the prospective home owner information as to what an indoor air quality assessment is and does, the benefits of such an assessment, a sample of some of the air quality factors which will be inspected as appropriate during the home inspection, and may ask follow up questions as to the health situation of the prospective home owner and associated family who will be living in the home, and finally presents the added cost of the service if it should be chosen by the prospective home owner. Following the script, an interested prospective home owner will be urged to affect closure of the sale with the home inspection service provider rather than leave the decision until the commencement of the actual on-site inspection.

The actual on-site inspection if it is to include an indoor air quality assessment, may then follow the IAQ inspection checklist of Table 2. Alternatively, if a conventional home inspection is converted on-site to one incorporating an IAQ inspection, then the conversion is simply accomplished by the inspector switching to the IAQ inspection checklist of Table 2. The IAQ inspection checklist, which is not intended to be exhaustive but merely illustrative, enables an inspector to progress through the air quality assessment factors systematically rather than unreliably from memory. For a properly trained IAQ inspector, the use of a systematic approach which is well documented (by the systematic use of the checklist for example), and which is standardized for use by all inspectors may , barring-negligence, provide reduced liability or a defence against liability claims brought by those asserting that, for example, mould was missed during the assessment. What may be brought forward in defence is evidence then of a systematic and reliable thoroughness and regulated competency having, it is projected, a highly unblemished track record and which provides clearly evident value to the consumer in exchange for the relatively low price paid by the consumer for the IAQ assessment service.

Included by way of example in Table 3 is the text and layout of a written offer explaining IAQ to prospective home owners who are scheduled for a conventional home inspection. The offer is advertising and entices them to cost effectively take advantage of an air quality assessment done at the time of the on site home inspection. The text might advantageously be used in a letter, facsimile transmission, electronic mail, or other form of communicating the written advertisement to those in a data base containing those home inspection clients who have yet to have had their conventional home inspection conducted. In testing, it has been applicant's experience that, for an inspector trained in assessing IAQ factors, the time it takes for conventional home inspection (for example, three hours) is not substantially lengthened, and in applicant's trials has not been altered at all, for the inclusion of an IAQ assessment. Consequently, the prospective home owner paying for an IAQ assessment to be done at the same time as the conventional home inspection is not paying for time of the inspector per se, but rather the inspector's expertise. Consequently, the additional profit is generated substantially without the use of additional time in the inspector's work day. Thus substantially the same number of inspectors may be completed in a day, whether they be solely conventional home inspections or the combination according to one aspect of the present invention, the latter then generating more revenue and profit.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

[image]

[image]

[image]

[image]

[image]

[image]

What is claimed is:

1. A method of doing business by a home inspection service provider comprising the steps of:
a) identifying a customer who has already committed to paying for a home inspection by the service provider, which home inspection is limited to a visual inspection of a building of interest to the customer as to determine the physical condition of the building and functioning of its associated major appliances and equipment;
b) continuing contact with the customer to provide an expanded sales-point time frame for educating the customer in respect of available indoor air quality inspection and assessment services and benefits thereof provided by the service provider and the risks attendant in ignoring indoor air quality;
c) educating the customer in the expanded sales-point time frame in respect of available indoor air quality inspection and assessment services and benefits thereof provided by the service provider, the risks attendant in ignoring indoor air quality, and the cost-effectiveness of having a home inspection and indoor air quality inspection and assessment done contemporaneously;
d) providing the customer with the choice of having an indoor air quality inspection and assessment conducted by the service provider contemporaneously with the home inspection of the building of interest;
e) recording the customer's preference; and,
f) performing the home inspection and, if in accordance with the customer's preference, also performing, contemporaneously with the home inspection, an indoor air quality inspection and assessment of the building of interest, whereby the source provider may charge a nominal sum acceptable to many purchasers of homes that otherwise would have been too expensive for those purchasers to consider.

2. The method of claim 1 wherein said steps are consecutive.

3. The method of claim 1 wherein said step of continuing contact with the customer is initiated prior to the conducting of the home inspection.

4. The method of claim 1 wherein said step of continuing contact with the customer is conducted contemporaneously with the conducting of the home inspection.

5. A method of conducting a home inspection business comprising the steps of:
a) offering to a customer a first inspection service limited to visual inspection of tangible attributes of a building;
b) offering to the same customer a second inspection service including at least visual inspection for physical sources of non-tangible air-borne contaminants in the building;
c) providing the first inspection service; and,
d) providing the second inspection service contemporaneously in the building with the first inspection service.

6. The method of claim 5 wherein said second inspection service includes steps chosen from the group of steps comprising:
a) inspecting landscaping/drainage for possible conditions which may cause moisture or infestation problems,
b) inspecting for exterior wall penetrations/damage so as to identify causes of past/present water intrusion and possible hidden moulds,
c) testing to defect high moisture levels behind finished walls conducive to mould growth,
d) checking venting of furnace and hot water tank for indications of flue gas backflow into the house which may indicate an air imbalance in the home,
e) reviewing on-site storage for hazardous products, including chemicals, phenols, asbestos and combustibles,
f) checking for odour to identify organics, phenols, mould/mildew,
g) checking of windows, basement and attic for mould/mildew including for fungus or other growths, and sampling materials for testing as required,
h) checking for excess moisture including window condensation, faulty toilet seals, high moisture levels behind tub surrounds,
i) checking carbon monoxide level,
j) inspecting for asbestos,
k) generally checking health issues of the customer so as to correlate the health issues to home IAQ factors.

7. The method of claim 6 wherein said first inspection service includes steps chosen from the group of steps comprising:
a) determining building type,
b) determining site condition,
c) determining weather conditions at time of conducting inspection,
d) determining site development,
e) inspecting the exterior of the building,
f) inspecting the roof of the building,
g) inspecting any attic of the building,
h) inspecting any garage of the building,
i) inspecting any mechanical/ventilation equipment of the building,
j) inspecting any interior development of the building.

8. The method of claim 7 wherein said first and second inspection services are conducted simultaneously and wherein:
a) said step of inspecting the roof of the building includes inspecting for active leaks, water staining or biological growth,
b) said step of inspecting any garage of the building includes:
(i) inspecting for odours and for causes of odours including organic or chemical causes and for visible rot or decay/mould,
(ii) inspecting for storage of gasoline, paints, garbage or organics,
c) said step of inspecting any mechanical heating and ventilating equipment of the building includes inspecting any humidifier for biological fungal build-up,
d) said step of inspecting any interior development includes:
(i) inspecting for the presence of cleaning products including of a perfumed or hazardous type,
(ii) inspecting for active water leaks, stains or biological fungal build-up,
(iii) inspecting windows for water damage or biological fungal build-up.

9. The method of claim 1 wherein said home inspection is a first inspection service and said indoor air quality inspection and assessment is a second inspection service, and wherein said second inspection service includes steps chosen from the group of steps comprising:
a) inspecting landscaping/drainage for possible conditions which may cause moisture or infestation problems,
b) inspecting for exterior wall penetrations/damage so as to identify causes of past/present water intrusion and possible hidden moulds,
c) testing to detect high moisture levels behind finished walls conducive to mould growth,
d) checking venting of furnace and hot water tank for indications of flue gas backflow into the house which may indicate an air imbalance in the home,
e) reviewing on-site storage for hazardous products, including chemicals, phenols, asbestos and combustibles,
f) checking for odour to identify organics, phenols, mould/mildew,
g) checking of windows, basement and attic for mould/mildew including for fungus or other growths, and sampling materials for testing
h) checking for excess moisture including window condensation, faulty toilet seals, high moisture levels behind tub surrounds,
i) checking carbon monoxide level
j) inspecting for asbestos.

10. The method of claim 9 wherein said first inspection service includes steps chosen from the group of steps comprising:
a) determining building type,
b) determining site condition,
c) determining weather conditions at time of conducting inspection,
d) determining site development,
e) inspecting the exterior of the building,
f) inspecting the roof of the building,
g) inspecting any attic of the building,
h) inspecting any garage of the building,
i) inspecting any mechanical/ventilation equipment of the building,
j) inspecting any interior development of the building.

11. The method of claim 10 wherein said first and second inspection services are conducted simultaneously and wherein:
a) said step of inspecting the roof of the building includes inspecting for active leaks, water staining or biological growth,
b) said step of inspecting any garage of the building includes:
(i) inspecting for odours and for causes of odours including organic or chemical causes and for visible rot or decay/mould,
(ii) inspecting for storage of gasoline, paints, garbage or organics,
c) said step of inspecting any mechanical equipment of the building includes inspecting any humidifier for biological fungal build-up,
d) said step of inspecting any interior development includes:
(i) inspecting for the presence of cleaning products including of a perfumed or hazardous type,
(ii) inspecting for active water leaks, stains or biological fungal build-up,
(iii) inspecting windows for water damage or biological fungal build-up.

12. The method of claim 5 wherein said steps are consecutive.

13. The method of claim 5 wherein said step of offering to the same customer a second inspection service is prior to said step of providing the first inspection service.

14. The method of claim 5 wherein said step of offering to the same customer a second inspection service is contemporaneously with the step of providing the first inspection service.
